(19) United States
(12) Patent Application Publication
(10) Pub. No.: US 2018/0031731 A1
(43) Pub. Date: Feb. 1, 2018

(54) SYSTEM AND METHOD FOR INCORPORATING GROUND PENETRATING RADAR EQUIPMENT ON SEISMIC SOURCE

(71) Applicant: CGG SERVICES SAS, Massy Cedex (FR)

(72) Inventors: Charles BOULANGER, Orsay (FR); Mathieu CHAPLAIN, Saint Aubin sur Mer (FR)

(21) Appl. No.: 15/522,040

(22) PCT Filed: Nov. 19, 2015
(86) PCT No.: PCT/IB2015/002373

§ 371 Date: Apr. 26, 2017

Related U.S. Application Data
(60) Provisional application No. 62/082,737, filed on Nov. 21, 2014.

(51) Int. Cl. G01V 11/00; G01S 13/86; G01S 13/88

(52) U.S. Cl. CPC G01V 11/00; G01S 13/885; G01S 13/86; G01V 3/12

(57) ABSTRACT

A system and method for incorporating ground penetrating radar equipment on seismic source is disclosed. The system includes a seismic source platform, a seismic source coupled to the seismic source platform and configured to emit a seismic signal, a transmitter coupled to the seismic source platform using at least one piece of mounting equipment and configured to emit electromagnetic signals, an ground penetrating radar antenna coupled to the seismic source platform using at least one piece of mounting equipment and configured to receive reflected electromagnetic signals, and a ground penetrating radar recorder coupled to the seismic source platform and configured to record reflected electromagnetic signals.

### CROSS-REFERENCE TO RELATED APPLICATION

This application claims the benefit under 35 U.S.C. §119(e) of U.S. Provisional Application Ser. No. 62/082,737 filed on Nov. 21, 2014, entitled “Radar Attached to a Vibrator,” which is incorporated by reference in its entirety for all purposes.

### TECHNICAL FIELD

The present disclosure relates generally to seismic exploration tools and processes and, more particularly, to systems and methods for incorporating ground penetrating radar equipment on seismic source.

### BACKGROUND

In the oil and gas industry, geophysical survey techniques are commonly used to aid in the search for and evaluation of subterranean hydrocarbon or other mineral deposits. Generally, a seismic energy source, or “seismic source,” generates a seismic signal that propagates into the earth and is partially reflected by subsurface seismic interfaces between underground formations having different acoustic impedances. The reflections are recorded by seismic detectors, or “receivers,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile may not directly show the location for oil and gas reservoirs, those trained in the field can use such profiles to more accurately predict the location of oil and gas, and thus reduce the chance of drilling a non-productive well.

In some seismic land data acquisitions, seismic vibrators, sometimes referred to as “vibroseis,” are used to impart the seismic waves into the earth. In land-based implementations, the seismic source signal is generally generated by a servo-controlled hydraulic vibrator, or “shaker unit,” mounted on a mobile base unit.

Another technique for performing geophysical surveys is the use of electromagnetic surveying (“EM”) techniques. EM surveying methods measure the response of subsurface formations to the diffusion or the propagation of naturally or artificially generated electromagnetic fields. Frequencies higher than approximately ten MHz are considered to be in the propagation domain. Frequencies lower than approximately 10 MHz are considered to be in the diffusive domain. GPR equipment working in the range of frequencies higher than approximately ten MHz is considered to be in the propagative domain.

One technique for performing EM surveys is the use of ground penetrating radar (“GPR”). GPR uses radar pulses to image the very near-surface layers or geophysical structure under the earth's surface. For example, GPR data can be used to characterize the geometry of sedimentary deposits near the surface of the earth. Near-surface layers may be more severely affected by environmental changes than other layers. For example, factors such as changes in moisture, and shifting particles may change the velocity, amplitude, or other aspects of wave propagation, and certain of these factors may disproportionately affect near-surface layers. Such changes may hinder the ability of seismic images to reflect the underground structures and structural changes. During a GPR acquisition, lower frequencies result in deeper investigations. However, lower frequencies also result in data with lower resolution. Higher frequencies result in shallower investigations, but with higher data resolution. The depth of a GPR investigation is mainly dependent on the water or clay content of investigated ground and the penetration of radar waves depends on the resistivity of the rocks. For example, the radar waves penetrate the subsurface less when the rocks are conductive (such as clay or salty layers).

In some GPR acquisitions, a radar transmitter emits electromagnetic energy that propagates into the earth and is partially reflected by subsurface seismic interfaces between underground formations. A radar antenna detects the reflected signals and the reflected signals are recorded by a recorder. The GPR data is used to generate a profile, or image, of the geophysical structure under the earth's surface.

The profile generated using GPR data may be used to characterize the weathered or weathering layer, referred to as the “V0” layer. The weathered layer is a layer of the earth's subsurface near the surface and is typically a low velocity layer and has a thickness ranging from less than one meter to up to 50 meters or more. Lateral and vertical velocity variations exist in the weathered layer, therefore an accurate characterization of the weathered layer is used to apply static corrections to seismic data to create an accurate image of the earth's subsurface.

### SUMMARY

In accordance with some embodiments of the present disclosure, a ground penetrating radar system is disclosed. The system includes a transmitter configured to emit electromagnetic signals, an antenna configured to receive reflected electromagnetic signals, a recorder configured to record reflected electromagnetic signals, and at least one piece of mounting equipment configured to couple the antenna to a seismic source platform.

In accordance with another embodiment of the present disclosure, a seismic exploration system is disclosed. The system includes a seismic source platform, a seismic source coupled to the seismic source platform and configured to emit a seismic signal, a transmitter coupled to the seismic source platform using at least one piece of mounting equipment and configured to emit electromagnetic signals, an antenna coupled to the seismic source platform using at least one piece of mounting equipment and configured to receive reflected electromagnetic signals, and a recorder coupled to the seismic source platform and configured to record reflected electromagnetic signals.

In accordance with a further embodiment of the present disclosure, a method for joint acquisition of seismic and ground penetrating radar data is disclosed. The method includes emitting a seismic signal by a seismic source mounted to a seismic source platform, obtaining a seismic dataset corresponding to the seismic signal emitted by the seismic source, emitting a radar signal by a ground penetrating radar equipment located in proximity to a seismic source line, and obtaining a ground penetrating radar dataset corresponding to the ground penetrating radar signal.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates a perspective view of a geophysical exploration system including a seismic source platform and GPR equipment in accordance with some embodiments of the present disclosure; and

FIG. 2 illustrates a flow chart of an example method for joint acquisition of seismic and ground penetrating radar data in accordance with some embodiments of the present disclosure; and

FIG. 3 illustrates an elevation view of an example seismic exploration system configured to produce images of the earth's subsurface geological structure in accordance with some embodiments of the present disclosure.

### DETAILED DESCRIPTION

Ground penetrating radar (“GPR”) systems use one or more GPR transmitters to emit an electromagnetic signal. Portions of the electromagnetic signal are reflected off of media in the earth's subsurface and are received by a GPR antenna. The signals received by the GPR antenna are recorded by a data recorder and later processed to create an image of the earth's subsurface. In another embodiment, the signals received by the GPR antenna may be instantaneously visible to an operator of the GPR equipment as an image of the near surface of the earth's subsurface. The GPR equipment, including the transmitter, antenna, and recorder, may be installed on a seismic source platform, such as a vibrator truck, that includes a seismic source used for seismic exploration. The installation of the GPR equipment on the seismic source platform may increase the efficiency of the geophysical survey and provide GPR data coverage at the same locations as the seismic data coverage.

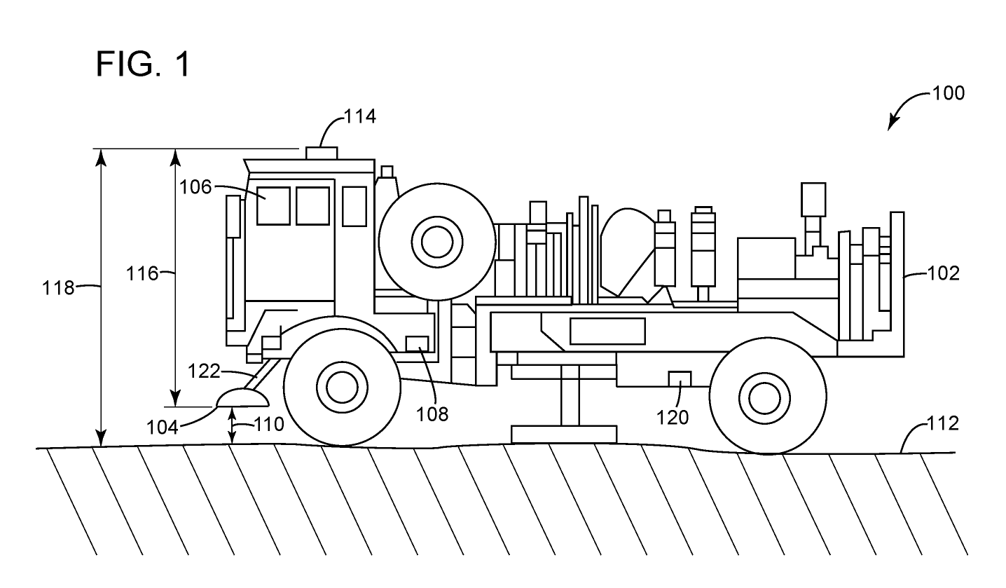

FIG. 1 illustrates a perspective view of a geophysical exploration system including a seismic source platform and GPR equipment in accordance with some embodiments of the present disclosure. Geophysical exploration system 100 includes seismic source platform 102. Seismic source platform 102 is shown in FIG. 1 as a vibrator truck, but it can be any other suitable platform that includes a seismic source. Seismic source platform 102 includes vibratory equipment that emits seismic signals. Additionally, seismic source platform 102 may include GPR equipment 104 that emits electromagnetic signals and receives reflected electromagnetic signals. In some embodiments, GPR equipment 104 includes a transmitter and an antenna housed in a single piece of equipment, as shown in FIG. 1. In other embodiments, the transmitter and antenna may be separate pieces of equipment installed on seismic source platform 102. In yet a further embodiment, GPR equipment 104 includes a single radar antenna that both emits electromagnetic signals and receives reflected electromagnetic signals. During a GPR acquisition, GPR equipment 104 may emit electromagnetic signals at lower frequencies to result in a deeper investigation and lower data resolution or at higher frequencies to result in a shallower investigation and higher data resolution. The depth of a GPR investigation may depend on the type of material below surface 112 such as the water or clay content and the resistivity of the material. In some embodiments, GPR equipment 104 may include an internal battery to provide power to the components of GPR equipment 104.

GPR equipment 104 may be installed at any suitable location on seismic source platform 102 including the front of seismic source platform 102 (as shown in FIG. 1), the back of seismic source platform 102, or either side of seismic source platform 102. In some embodiments, GPR equipment 104 may be installed on the front of seismic platform 102 such that the operator of seismic platform 102 can monitor the position of GPR equipment 104 when moving seismic platform 102. GPR equipment 104 may be installed in an orientation such that the antenna in GPR equipment 104 is oriented parallel surface 112. GPR equipment 104 may be attached to seismic source platform 102 using mounting equipment 122. Mounting equipment 122 may provide stability to GPR equipment 104 during the GPR acquisition such that vibration experienced by GPR equipment 104 is minimized and provide proper positioning of GPR equipment 104 relative to seismic source platform 102. For example, mounting equipment 122 may be used to position GPR equipment 104 parallel to surface 112. Mounting equipment 122 may couple GPR equipment 104 to seismic source platform 102. For example, mounting equipment 122 may be a rectangular piece of material, such as plastic, composite, fiberglass, Teflon, aluminum or any other suitable material that is light, corrosion resistant and nonmagnetic or any combination thereof, that may be coupled to GPR equipment 104 at one end and coupled to seismic source platform 102 at another end. As another example, mounting equipment 122 may be a flat plate of material attached to seismic source platform 102 and have protrusions extending from the plate to which GPR equipment 104 may be coupled. Mounting equipment 122 may be stiffened with any suitable stiffening support such as support arms, braces, or ribs, to reduce vibrations and movement that is transferred to GPR equipment 104 when seismic source platform 102 is performing a seismic acquisition or while seismic source platform 102 is maneuvering around the seismic survey area. In some embodiments, mounting equipment 122 may couple to GPR equipment 104 and seismic source platform 102 using any suitable fastener such as a screw, a pin, a bolt, a clamp, or any other suitable fastener. In some embodiments, mounting equipment 122 may be coupled to GPR equipment 104 and seismic source platform 102 using an interference fit, an adhesive, or other suitable coupling mechanism. Mounting equipment 122 may be designed to avoid interference with the seismic acquisition and the GPR acquisition such as avoiding metallic or magnetic materials.

Mounting equipment 122 may adjust the position of GPR equipment 104 above surface 112 by adjusting the height, orientation, and location of GPR equipment 104 relative to surface 112. Height 110 at which GPR equipment 104 is located above surface 112 of the earth may be based on the requirements of the GPR acquisition. For example, height 110 may be selected to ensure GPR data quality and avoid perturbations between seismic source platform 102 and GPR equipment 104. In some embodiments, height 110 may be based on the terrain of the seismic exploration area such that seismic source platform 102 has adequate clearance when traveling from one location to another. In some embodiments, height 110 may be based on the signal strength of GPR equipment 104 such that height 110 may be reduced to increase the signal strength. For example, height 110 may be any distance between approximately zero centimeters to approximately one meter. In some embodiments, mounting hardware 122 may be movable such that height 110 may be adjusted throughout the GPR acquisition. For example, mounting hardware 122 may rotate to lower GPR equipment 104 to be in contact with surface 112 or raise GPR equipment 104 to be a distance above surface 112 of the earth. Height 110 may be recorded for use during data processing.

GPR equipment 104 may be communicatively coupled to recorder 108 located on seismic source platform 102 via any suitable method for transmitting data between two devices including wired and wireless protocols. For example, any short range wireless protocol may be used to communicatively couple GPR equipment 104 and recorder 108 including Wi-Fi, near field communication (NFC), Bluetooth, infrared (IR), ultra-wideband (UWB), and ZigBee or any other suitable communication protocol.

Recorder 108 may be installed at any location on seismic source platform 102. For example, recorder 108 may be located in operator cabin 106. GPR equipment 104 or recorder 108 may be installed such that the distance between GPR equipment 104 and recorder 108 is within an effective distance for the communication protocol used to couple GPR equipment 104 and recorder 108.

Recorder 108 may be communicatively coupled with global positioning system (“GPS”) system 114 via any suitable method for transmitting data between two devices including wired and wireless protocols. For example, any short range wireless protocol may be used to communicatively couple GPS system 114 and recorder 108 including Wi-Fi, NFC, Bluetooth, IR, UWB, and ZigBee or any other suitable communication protocol. GPS system 114 may be installed at any location on seismic source platform 102 where GPS system 114 has a line of sight to GPS satellites. GPS system 114 may be used to record the location of seismic source platform 102 and/or GPR equipment 104 during the geophysical exploration of data from both the seismic acquisition and the GPR acquisition. The height difference between GPS system 114 and GPR equipment 104 may be used during data processing to calculate the elevation of GPR equipment based on the elevation recorded by GPS system 114. Distance 116 is the distance between height 118—the distance GPS system 114 is above surface 112—and height 110.

During seismic and GPR acquisitions, the vibration equipment on seismic source platform 102 may create seismic signals and GPR equipment 104 may be simultaneously emitting electromagnetic signals. The seismic signals emitted by the seismic equipment on seismic source platform 102 and the electromagnetic signals emitted by GPR equipment 104 do not interfere with one another such that the data from both acquisitions is usable. However, in some embodiments, GPR equipment 104 may be shielded to reduce the noise received by the antenna and increase the signal to noise ratio in the GPR data. For example, GPR equipment 104 may include a directional antenna such that the antenna is oriented to receive signals from the direction of surface 112 or GPR equipment 104 may include additional materials, such as insulating foam around the antenna, to reduce the noise received by the antenna. Shielding may allow the antenna to record only reflected waves from below surface 112 and not waves reflected off structures or equipment located above surface 112 (referred to as “air waves”). The orientation of GPR equipment 104 may be adjusted to reduce the noise in the GPR data and may be adjusted based on noise testing. The noise received by the antenna may be caused by interference between the radar equipment, GPS equipment 114, the seismic acquisition equipment, or seismic source platform 102.

During a seismic acquisition, an operator of seismic source platform 102 may activate recorder 108 at the beginning of the acquisition. Recorder 108 may then activate GPR equipment 104 such that GPR data is continuously recorded during the acquisition. The operator can then perform the seismic acquisition without additional interaction with GPR equipment 104 thus reducing the potential for operator error during the GPR acquisition. In some embodiments, the operator of seismic source platform 102 may turn recorder 108 on and off during the seismic acquisition such that the GPR data is recorded discontinuously.

At intervals throughout the seismic acquisition, such as at the end of each day, data from recorder 108 may be downloaded, stored, and used for subsequent processing to create an image of the weathered layer of the earth's subsurface. In some embodiments, data from recorder 108 may be wirelessly transmitted to a data processing system (not expressly shown) via any suitable wireless protocol such as Wi-Fi, NFC, Bluetooth, IR, UWB, and ZigBee or any other suitable communication protocol. The image can be used for near field static correction of the seismic data and for determining the thickness of the weathered layer.

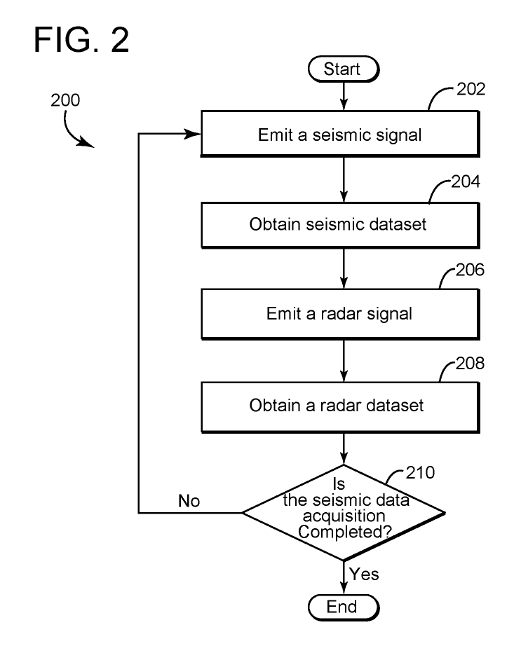

FIG. 2 illustrates a flow chart of an example method 200 for joint acquisition of seismic and ground penetrating radar data in accordance with some embodiments of the present disclosure. The seismic and GPR data may be used to generate images of the earth's subsurface. The steps of method 200 may be performed by a user, seismic acquisition equipment, GPR acquisition equipment, or any combination thereof. Collectively, the user, the seismic acquisition equipment, and the GPR acquisition equipment may be referred to as “acquisition equipment.”

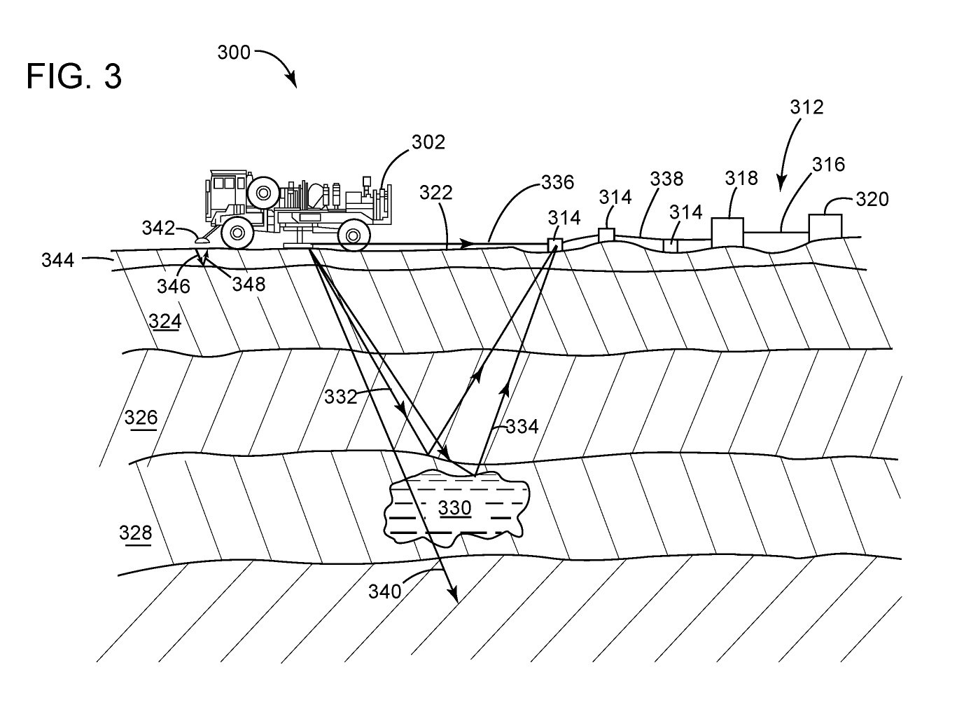

The method 200 may begin at step 202, where the acquisition equipment may emit a seismic signal. The seismic signal may be emitted by any suitable seismic source, such as a seismic source located on seismic source platform 102 shown in FIG. 1. The seismic source may be any suitable vibratory seismic source that provides the ability to control the phase and amplitude of the emitted seismic signal, such as hydraulic, pneumatic, electric, or magnetorestrictive actuators; a piezoelectric source; or an electrodynamic linear motor actuator source. An example of a seismic source may be shown and discussed in further detail in FIG. 3.

In step 204, the acquisition equipment may obtain a seismic dataset corresponding to the seismic signal emitted in step 202. The seismic dataset may be recorded by receivers from reflected or refracted seismic waves emitted by the seismic source in step 202. The seismic dataset may be processed using any suitable data processing technique.

In step 206, the acquisition equipment may emit a GPR signal. In some embodiments, the GPR signal may be emitted by a GPR antenna mounted on the seismic source platform, such as GPR equipment 104 shown in FIG. 1. In other embodiments, the GPR signal may be emitted by a GPR antenna located in proximity to a seismic source line. The GPR signal may be emitted at the same time as the seismic signal emitted in step 202, may be emitted during the time intervals between individual seismic signal emissions, or both. For example, an operator of the acquisition equipment may turn on the GPR equipment at the beginning of a seismic acquisition and allow the GPR equipment to run continuously throughout the acquisition.

The acquisition equipment may adjust the height at which the GPR equipment is located when the GPR equipment emits the GPR signal. For example, the GPR equipment may be lowered closer to the earth's surface or may be raised based on the parameters of the GPR acquisitions. The acquisition equipment may record the height of the GPR equipment for use during processing of the GPR dataset obtained in step 208.

Optionally, the acquisition equipment may determine a frequency at which to emit the GPR signal. For example, the GPR equipment may emit electromagnetic signals at lower frequencies to result in a deeper investigation and lower data resolution or at higher frequencies to result in a shallower investigation and higher data resolution. The frequency at which the GPR signal is emitted may be based on a survey plan of the acquisition area. The depth of a GPR investigation may depend on the type of material below the earth's surface such as the water or clay content and the resistivity of the material.

In step 208, the acquisition equipment may obtain a GPR dataset corresponding to the GPR signal emitted in step 206. The GPR dataset may be recorded by receivers from reflected or refracted GPR waves emitted by the GPR equipment in step 206. The GPR dataset may be processed using any suitable data processing technique.

In step 210, the acquisition equipment may determine whether the seismic acquisition is complete. If the seismic acquisition is complete, method 200 is complete; otherwise method 200 may return to step 202 to emit the next seismic signal. As stated above, steps 206 and 208 may be performed continuously throughout method 200.

Modifications, additions, or omissions may be made to method 200 without departing from the scope of the present disclosure. The order of the steps may be performed in a different manner than that described and some steps may be performed at the same time. For example, steps 206 and 208 may be performed before, after, or simultaneously with steps 202 and 204. Additionally, each individual step may include additional steps without departing from the scope of the present disclosure. Further, more steps may be added or steps may be removed without departing from the scope of the disclosure.

The seismic source platform with attached GPR equipment described with reference to FIG. 1 is used to enhance the effectiveness of a system used to emit seismic signals, receive reflected signals, and process the resulting data to image the earth's subsurface. FIG. 3 illustrates an elevation view of an example seismic exploration system 300 configured to produce images of the earth's subsurface geological structure in accordance with some embodiments of the present disclosure. The images produced by system 300 allow for the evaluation of subsurface geology. System 300 may include one or more seismic energy sources 302 and one or more receivers 314 which are located within a pre-determined exploration area. The exploration area may be any defined area selected for seismic survey or exploration. Survey of the exploration area may include the activation of seismic source 302 that radiates an acoustic wave field that expands downwardly through the layers beneath the earth's surface. The seismic wave field is then partially reflected or refracted from the respective layers as a wave front recorded by receivers 314. For example, seismic source 302 generates seismic waves and receivers 314 record seismic waves 332 and 334 reflected from interfaces between subsurface layers 324, 326, and 328, oil and gas reservoirs, such as target reservoir 330, or other subsurface structures. Subsurface layers 324, 326, and 328 may have various densities, thicknesses, or other characteristics. Target reservoir 330 may be separated from surface 322 by multiple layers 324, 326, and 328. As the embodiment depicted in FIG. 2 is exemplary only, there may be more or fewer layers 324, 326, or 328 or target reservoirs 330. Similarly, there may be more or fewer seismic waves 332 and 334. Additionally, some seismic source waves will not be reflected, as illustrated by seismic wave 340. In addition, in some cases other waves (not expressly shown) may be present that may be useful in imaging a formation or for computing seismic attributes such as refracted waves or mode converted waves.

Seismic energy source 302 may be referred to as an acoustic source, seismic source, energy source, and source 302. In some embodiments, seismic source 302 is located on, or proximate to surface 322 of the earth within an exploration area. A particular seismic source 302 may be spaced apart from other similar seismic sources. Seismic source 302 may be operated by a central controller that coordinates the operation of several seismic sources 302. Further, a positioning system, such as a GPS, may be utilized to locate and time-correlate seismic sources 302 and receivers 314. Multiple seismic sources 302 may be used to improve data collection efficiency, provide greater azimuthal diversity, improve the signal to noise ratio, and improve spatial sampling. The use of multiple seismic sources 302 can also input a stronger seismic signal into the ground than a single, independent seismic source 302. Seismic sources 302 may also have different capabilities and the use of multiple seismic sources 302 may allow for some seismic sources 302 to be used at lower frequencies in the spectrum and other seismic sources 302 at higher frequencies in the spectrum.

Seismic source 302 may comprise any type of seismic device that generates controlled seismic energy used to perform reflection or refraction seismic surveys, such as seismic vibratory sources such as a seismic vibrator, vibroseis, an air gun, a thumper truck, marine vibrators, magnetic vibrators, piezoelectric vibrators, or any source suitable for emitting a controlled seismic signal. In some embodiments, seismic source 302 may be a piezoelectric source, an encoded pulsed source, or other similar system, designed to generate a monofrequency. For example, seismic source platform 102 shown in FIG. 1 may include seismic source 302.

Seismic source 302 may radiate varying frequencies or one or more monofrequencies of seismic energy into surface 322 and subsurface formations during a defined interval of time. Seismic source 302 may impart energy through a sweep of multiple frequencies or at a single monofrequency, or through a combination of at least one sweep and at least one monofrequency or through the use of pseudorandom sweeps. In some embodiments, seismic source 302 may be part of an array of seismic sources and may emit a series of frequencies such that no source in the array emits the same signal at the same time. A seismic signal may be discontinuous so that seismic source 302 does not generate particular frequencies between the starting and stopping frequency and receivers 314 do not receive or report data at the particular frequencies.

Seismic exploration system 300 may include monitoring equipment 312 that operates to record reflected energy seismic waves 332, 334, and 336. Monitoring equipment 312 may include one or more receivers 314, network 316, recording unit 318, and processing unit 320. In some embodiments, monitoring equipment 312 may be located remotely from seismic source 302.

Receiver 314 may be located on, buried beneath, or proximate to surface 322 of the earth within an exploration area. Receiver 314 may be any type of instrument that is operable to transform seismic energy or vibrations into a signal compatible with the data acquisition system, for example a voltage signal, a current signal, or an optical signal. For example, receiver 314 may be a vertical, horizontal, or multicomponent geophone, accelerometers, or optical fiber or distributed acoustic sensor (DAS) with wire or wireless data transmission, such as a three component (3C) geophone, a 3C accelerometer, hydrophone, or a 3C Digital Sensor Unit (DSU). Multiple receivers 314 may be utilized within an exploration area to provide data related to multiple locations and distances from seismic sources 302. Receivers 314 may be positioned in multiple configurations, such as linear, grid, array, or any other suitable configuration. In some embodiments, receivers 314 may be positioned along one or more strings 338. Each receiver 314 is typically spaced apart from adjacent receivers 314 in the string 338. Spacing between receivers 314 in string 338 may be approximately the same preselected distance, or span, or the spacing may vary depending on a particular application, exploration area topology, or any other suitable parameter.

One or more receivers 314 transmit raw seismic data from reflected seismic energy via network 316 to recording unit 318. Recording unit 318 transmits raw seismic data to processing unit 320 via network 316. Processing unit 320 performs seismic data processing on the raw seismic data to prepare the data for interpretation. Although discussed separately, recording unit 318 and processing unit 320 may be configured as separate units or as a single unit. Recording unit 318 or processing unit 320 may include any equipment or combination of equipment operable to compute, classify, process, transmit, receive, store, display, record, or utilize any form of information, intelligence, or data. Recording unit 318 may collect the GPR data from recorder 108 shown in FIG. 1 and processing unit 320 may process the GPR data. For example, recording unit 318 and processing unit 320 may include one or more personal computers, storage devices, servers, or any other suitable device and may vary in size, shape, performance, functionality, and price. Recording unit 318 and processing unit 320 may include random access memory (RAM), one or more processing resources, such as a central processing unit (CPU) or hardware or software control logic, or other types of volatile or non-volatile memory. Additional components of recording unit 318 and processing unit 320 may include one or more disk drives, one or more network ports for communicating with external devices, one or more input/output (I/O) devices, such as a keyboard, a mouse, or a video display. Recording unit 318 or processing unit 320 may be located in a station truck or any other suitable enclosure.

Network 316 may be configured to communicatively couple one or more components of monitoring equipment 312 with any other component of monitoring equipment 312. For example, network 316 may communicatively couple receivers 314 with recording unit 318 and processing unit 320. Further, network 314 may communicatively couple a particular receiver 314 with other receivers 314. Network 314 may be any type of network that provides communication, such as one or more of a wireless network, a local area network (LAN), or a wide area network (WAN), such as the Internet. For example, network 314 may provide for communication of reflected energy and noise energy from receivers 314 to recording unit 318 and processing unit 320.

The seismic survey conducted using seismic source 302 may be repeated at various time intervals to determine changes in target reservoir 330. The time intervals may be months or years apart. Data may be collected and organized based on offset distances, such as the distance between a particular seismic source 302 and a particular receiver 314 and the amount of time it takes for seismic waves 332 and 334 from a seismic source 302 to reach a particular receiver 314. Data collected during a survey by receivers 314 may be reflected in traces that may be gathered, processed, and utilized to generate a model of the subsurface structure or variations of the structure, for example 4D monitoring.

Seismic source 302 may additionally include GPR equipment 342 used to generate an image of near surface layer 344. GPR equipment 342 may emit electromagnetic signals and receive reflected electromagnetic signals. For example, GPR equipment 342 emits an electromagnetic signal 346 and receives reflected signal 348 that is reflected off layers in near surface layer 344. During a GPR acquisition, GPR equipment 342 may emit electromagnetic signals at lower frequencies to result in a deeper investigation and lower data resolution or at higher frequencies to result in a shallower investigation and higher data resolution. The depth of a GPR investigation may depend on the type of material below surface 322 such as the water or clay content, the resistivity of the material, and the depth of a water table below surface 322.

As the embodiment depicted in FIG. 2 is exemplary only, there may be more electromagnetic signals 346 and 348. Reflected signal 348 may be recorded by a recorder (such as recorder 108 shown in FIG. 1) on seismic source 302. The recorder may collect GPR data. Periodically during a seismic acquisition, the GPR data may be transmitted to processing unit 320 via a wireless network using any suitable wireless protocol such as Wi-Fi, NFC, Bluetooth, IR, UWB, and ZigBee or any other suitable communication protocol. Processing unit 320 performs GPR data processing on the raw GPR data to prepare the data for interpretation and to generate an image of the weathered layer.

GPR equipment 342 may be used to simultaneously perform a GPR acquisition during the seismic acquisition or may be used to perform GPR acquisitions during the periods of time between emissions of seismic waves by seismic source 302, thus increasing the efficiency of the acquisition. For example, once GPR equipment 342 is mounted to seismic source 302, at the beginning of each day during a seismic acquisition, the operator of seismic source 302 may power-on GPR equipment 342 and record data continuously during the day. At the end of the day, the operator may power-off GPR equipment 342 and download the data or transmit the data to processing unit 320.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but may be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. For example, a computer processor may process the GPR data to generate an image of the weathered layer.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A ground penetrating radar system, comprising:
a transmitter configured to emit electromagnetic signals;
an antenna configured to receive reflected electromagnetic signals;
a recorder configured to record reflected electromagnetic signals; and
at least one piece of mounting equipment configured to couple the antenna to a seismic source platform.

2. The ground penetrating radar system of claim 1, wherein the at least one piece of mounting equipment is configured to adjust a position of the antenna above a surface of the earth.

3. The ground penetrating radar system of claim 1, wherein the antenna includes noise shielding.

4. The ground penetrating radar system of claim 1, wherein the antenna includes a directional antenna.

5. The ground penetrating radar system of claim 1, further comprising an internal battery configured to provide power to the antenna.

6. The ground penetrating radar system of claim 1, further comprising at least one piece of global positioning system equipment coupled to the recorder.

7. The ground penetrating radar system of claim 1, wherein the transmitter and the antenna are a single piece of equipment.

8. A seismic exploration system, comprising:
a seismic source platform;
a seismic source coupled to the seismic source platform and configured to emit a seismic signal;
a transmitter coupled to the seismic source platform using at least one piece of mounting equipment and configured to emit electromagnetic signals;
an antenna coupled to the seismic source platform using at least one piece of mounting equipment and configured to receive reflected electromagnetic signals; and
a recorder coupled to the seismic source platform and configured to record reflected electromagnetic signals.

9. The seismic exploration system of claim 8, wherein the at least one piece of mounting equipment is configured to adjust a position of the antenna above a surface of the earth.

10. The seismic exploration system of claim 8, wherein the antenna includes noise shielding.

11. The seismic exploration system of claim 8, wherein the antenna includes a directional antenna.

12. The seismic exploration system of claim 8, further comprising at least one piece of global positioning system equipment coupled to the seismic source platform and the recorder.

13. The seismic exploration system of claim 8, wherein the transmitter and the antenna are a single piece of equipment.

14. A method for joint acquisition of seismic and ground penetrating radar data, comprising:
emitting a seismic signal by a seismic source mounted to a seismic source platform;
obtaining a seismic dataset corresponding to the seismic signal emitted by the seismic source;
emitting a radar signal by a ground penetrating radar equipment located in proximity to a seismic source line; and
obtaining a ground penetrating radar dataset corresponding to the ground penetrating radar signal.

15. The method of claim 14, wherein the seismic signal and the ground penetrating radar signal are emitted simultaneously.

16. The method of claim 14, wherein the position of the ground penetrating radar equipment above a surface of the earth is adjusted based on a terrain of a seismic exploration area.

17. The method of claim 16, further comprising recording the position of the ground penetrating radar equipment above the surface of the earth.

18. The method of claim 14, further comprising identifying a frequency at which to emit the ground penetrating radar signal.

19. The method of claim 14, wherein the ground penetrating radar equipment continuously emits the ground penetrating radar signal throughout a seismic exploration acquisition.

20. The method of claim 14, wherein the ground penetrating radar equipment is mounted to the seismic source platform.
